(19) United States
(12) Patent Application Publication
(10) Pub. No.: US 2007/0047668 A1
(43) Pub. Date: Mar. 1, 2007

(54) Single side band modulator module and single side band modulator device using the same

(75) Inventors: Sung-Kee Kim, Suwon-si (KR); Hoon Kim, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/514,438

(22) Filed: Sep. 1, 2006

(30) Foreign Application Priority Data
Sep. 1, 2005 (KR) 2005-81282

(51) Int. Cl. H04L 27/04

(52) U.S. Cl. 375/301

(57) ABSTRACT

A single side band (SSB) modulator module using a carrier frequency includes: first and second Mach-Zender interferometers for modulating the carrier frequency and first and second signals into an SSB signal; and an arm, which is connected to both ends at which the first and second Mach-Zender interferometers are connected, splits the carrier frequency, and outputs a split portion to the first and second Mach-Zender interferometers.

### CLAIM OF PRIORITY

This application claims priority under 35 U.S.C. § 119 to an application entitled “Single Side Band Modulator Module and Single Side Band Modulator Device Using the Same,” filed in the Korean Intellectual Property Office on Sep. 1, 2005 and assigned Serial No. 2005-81282, the contents of which are incorporated herein by reference.

### BACKGROUND OF THE INVENTION

1. Field of the Invention

The present invention relates generally to a single side band (SSB) modulator device for providing a SSB transmission, and in particular, to an SSB modulator device for simultaneously transmitting an SSB and a carrier frequency.

2. Description of the Related Art

A spectrum of a modulated signal obtained by modulating amplitude-modulated (AM) data into a carrier frequency forms an upper side band and a lower side band symmetrically. A signal transmission method using only one side band by removing the other side band and its carrier frequency is known as a single side band (SSB) transmission.

The upper side band denotes a band obtained by moving channels of the modulated signal to a high frequency band, and the lower side band denotes a band obtained by reversing the channels of the modulated signal and moving the reversed channels to a low frequency band.

The SSB transmission can minimize power consumption for an amplifier and other components by reducing an occupation frequency in double side band (DSB) transmission into a half. In addition, since the bandwidth in the SSB transmission is narrow, noise is reduced, thereby improving a signal-to-noise ratio (SNR) and receive sensitivity. An SSB modulator device for the SSB transmission filters a frequency in an optical domain using an optical fiber Brag grating (OFBG). However, since it is not easy to manufacture the OFBG and the stability of the OFBG is low, it is difficult to use the OFBG in reality. To address this, LiNbO₃ based SSB modulator devices having excellent stability have been suggested to solve the problems of the SSB modulator.

FIG. 1 is a configuration of a conventional SSB modulator device 100 for SSB transmission. As shown, the SSB modulator device 100 includes an SSB modulator module 110, a hybrid coupler 130, and a light source 120. The light source 120 generates a carrier frequency. The hybrid coupler 130 forms first and second signals having phases 0° and 90° from input data (a) and outputs the first and second signals to the SSB modulator module 110.

The SSB modulator module 110 includes LiNbO₃ based Mach-Zender interferometers 111 and 112 having a plurality of arms, couples the first and second signals having phases 0° and 90° input from the hybrid coupler 130 into an SSB signal (b), and outputs the SSB signal (b) to the outside.

Referring to FIGS. 2A to 2D are eyediagrams according to variations of the amplitude of the carrier frequency. In particular, the eyediagram illustrated in FIG. 2A shows when the carrier frequency having the lowest amplitude is smallest, and the eyediagram illustrated in FIG. 2D shows when the carrier frequency having the highest amplitude is greatest and clearest.

According to the prior art, the carrier frequency removed SSB modulation cannot use a receiver using a direct detection method and must use a complicated optical interferometer type detector.

To solve the above-describe problem, a method of applying an offset to a conventional SSB modulator device can be used. However, in this case, an undesirable other side band is mixed in. That is, a lower side band may be mixed in when an upper side band is transmitted, or the upper side band may be mixed in when the lower side band is transmitted.

### SUMMARY OF THE INVENTION

An object of the present invention is to substantially solve at least the above problems and/or disadvantages and to provide at least the advantages below. Accordingly, the present invention provides a single side band (SSB) modulator module for transmitting an SSB signal with a carrier frequency.

According to one aspect of the present invention, there is provided a single side band (SSB) modulator module using a carrier frequency, the SSB modulator module comprising: first and second Mach-Zender interferometers for modulating the carrier frequency and first and second signals into an SSB signal; and an arm, which is connected to both ends at which the first and second Mach-Zender interferometers are connected, splits the carrier frequency, and outputs a split portion to the first and second Mach-Zender interferometers.

### BRIEF DESCRIPTION OF THE DRAWINGS

The above features and advantages of the present invention will become more apparent from the following detailed description when taken in conjunction with the accompanying drawings in which:

FIG. 1 is a configuration of a conventional SSB modulator device;

FIGS. 2A to 2D are eyediagrams according to the amplitude of a carrier frequency;

FIGS. 3A to 3D are configurations of an SSB modulator device according to a first embodiment of the present invention;

FIGS. 4A to 4C are configurations of an SSB modulator device according to a second embodiment of the present invention;

FIG. 5 is a configuration of an SSB modulator device according to a third embodiment of the present invention; and

FIG. 6 is a configuration of an SSB modulator device according to a fourth embodiment of the present invention.

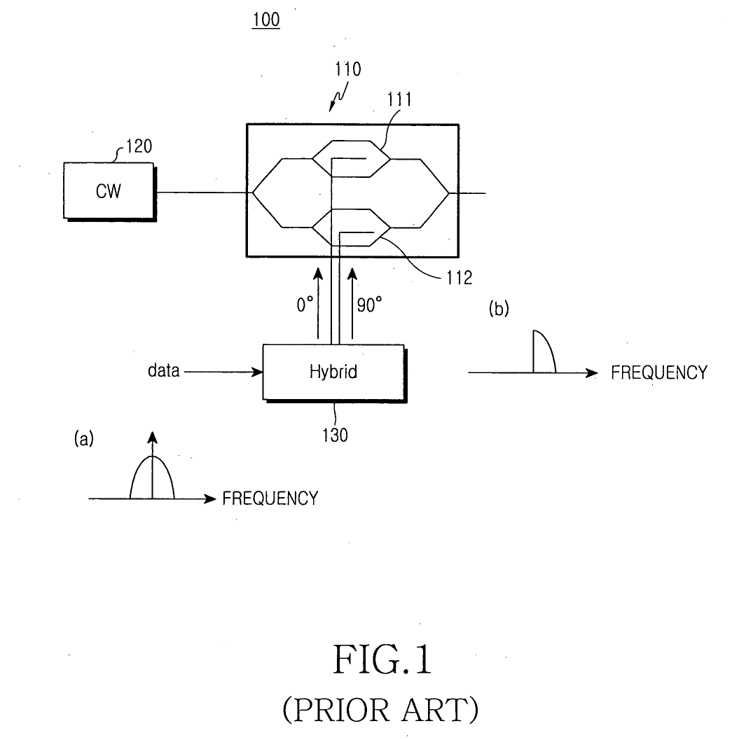

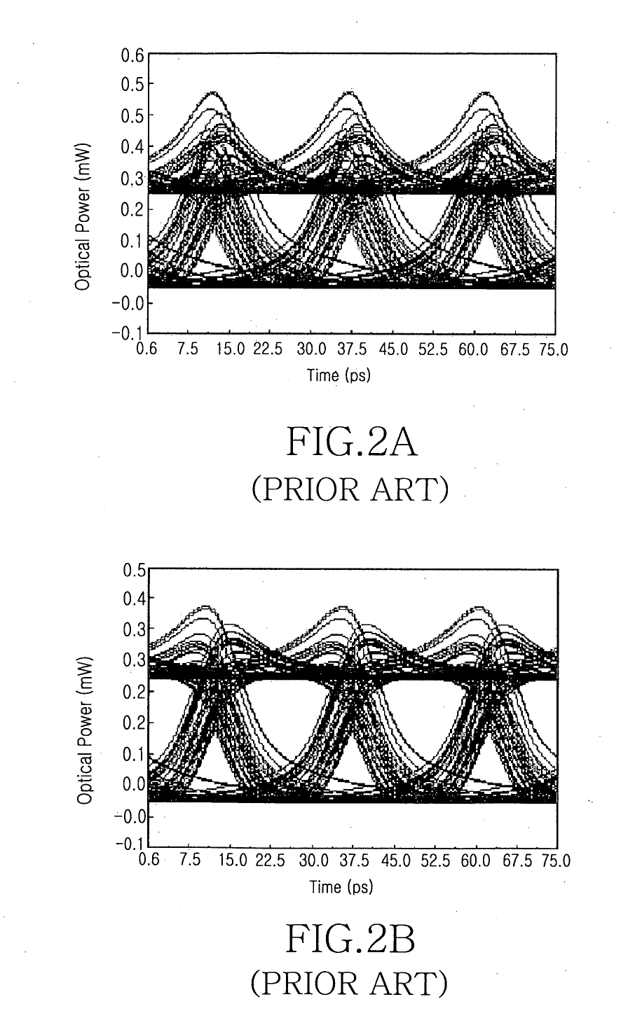

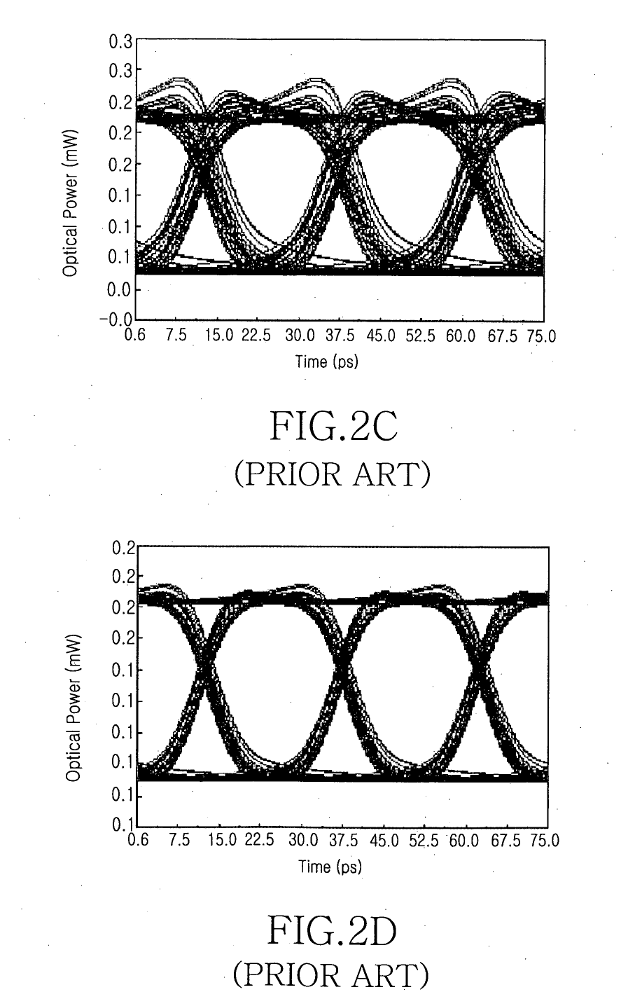

### DETAILED DESCRIPTION OF THE INVENTION

Embodiments of the present invention will be described herein below with reference to the accompanying drawings. For the purposes of clarity and simplicity, well-known functions or constructions are not described in detail as they would obscure the invention in unnecessary detail.

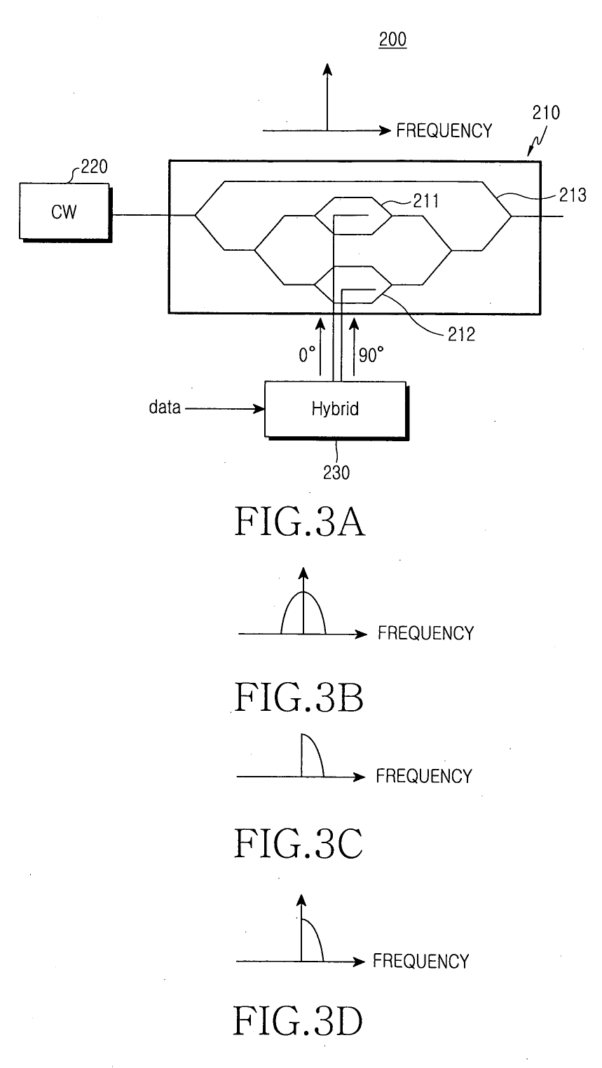

FIGS. 3A to 3D are configurations of an SSB modulator device 200 according to a first embodiment of the present invention. As shown, the SSB modulator device 200 includes a light source 220 for generating a carrier frequency (a), a hybrid coupler 230 for generating first and second signals having a 90° phase difference from data (b) input from the outside, and an SSB modulator module 210. The light source 220 may include a continuous wave (CW) laser.

The SSB modulator module 210 includes first and second Mach-Zender interferometers 211 and 212 for modulating the carrier frequency (a) and the first and second signals into an SSB signal (c), and an arm 213.

The arm 213 has a y-branch structure, which is connected to both ends at which the first and second Mach-Zender interferometers 211 and 212 are connected, splits the amplitude of the carrier frequency (a) input from the light source 220, outputs a split portion to the first and second Mach-Zender interferometers 211 and 212, and outputs an SSB signal (d), which includes the carrier frequency (a), obtained by coupling the other split portion of the carrier frequency (a) and the SSB signal (c) modulated by the first and second Mach-Zender interferometers 211 and 212 to the outside of the SSB modulator module 210. A split proportion of the carrier frequency (a) split by the arm 213 can be controlled if necessary, and the amplitude of the carrier frequency included in a finally output SSB signal can be determined according to the split proportion.

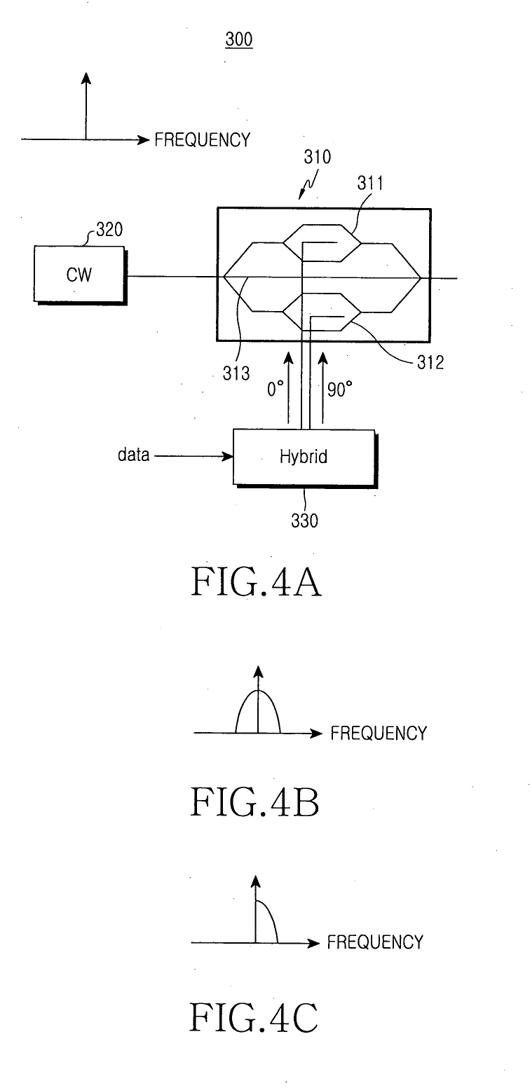

FIGS. 4A to 4C are configurations of an SSB modulator device 300 according to a second embodiment of the present invention. As shown, the SSB modulator device 300 includes a light source 320 for generating a carrier frequency (a), a hybrid coupler 330 for generating first and second signals having a 90° phase difference from data (b) input from the outside, and an SSB modulator module 310.

The SSB modulator module 310 includes first and second Mach-Zender interferometers 311 and 312 for modulating the carrier frequency (a) and the first and second signals into an SSB signal (c), and an arm 313 for coupling the carrier frequency (a) generated by the light source 320 with the SSB signal (c).

The arm 313 connects both ends of the first and second Mach-Zender interferometers 311 and 312 and is located to cross between the first and second Mach-Zender interferometers 311 and 312.

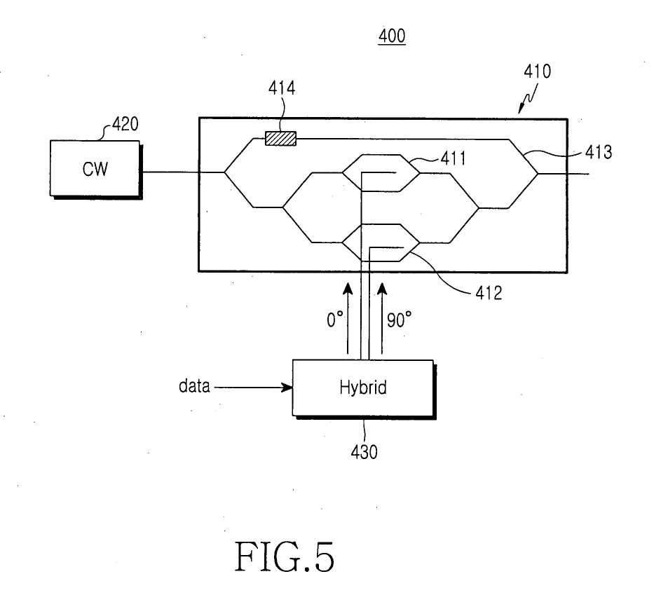

FIG. 5 is a configuration of an SSB modulator device 400 according to a third embodiment of the present invention. As shown, the SSB modulator device 400 includes a light source 420 for generating a carrier frequency, a hybrid coupler 430 for generating first and second signals having a 90° phase difference from data input from the outside, and an SSB modulator module 410.

The SSB modulator module 410 includes first and second Mach-Zender interferometers 411 and 412 for modulating the carrier frequency and the first and second signals into an SSB signal, an arm 413, and a variable optical attenuator 414 located on the arm 413.

The arm 413 has a y-branch structure, which is connected to both ends at which the first and second Mach-Zender interferometers 411 and 412 are connected, and splits the amplitude of the carrier frequency input from the light source 420. The variable optical attenuator 414 can adjust the amplitude of the carrier frequency.

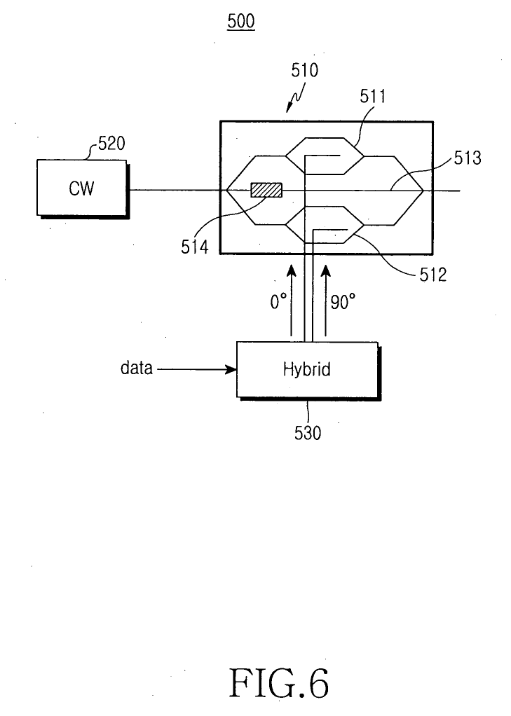

FIG. 6 is a configuration of an SSB modulator device 500 according to a fourth embodiment of the present invention. As shown, the SSB modulator device 500 includes a light source 520 for generating a carrier frequency, a hybrid coupler 530 for generating first and second signals having a 90° phase difference from data input from the outside, and an SSB modulator module 510.

The SSB modulator module 510 includes first and second Mach-Zender interferometers 511 and 512 for generating an SSB signal, an arm 513 for coupling the carrier frequency with the SSB signal, and a variable optical attenuator 514 located on the arm 513.

As described above, an SSB modulator module according to the embodiments of the present invention can generate an SSB signal including a carrier frequency by further including an arm for splitting the carrier frequency. Thus, the generation of an undesired SSB, which can be generated by conventional modulators for generating an SSB signal including a carrier frequency, can be suppressed, and if necessary, the amplitude of the carrier frequency can be controlled.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A single side band (SSB) modulator module using a carrier frequency, comprising:
first and second Mach-Zender interferometers for modulating a first signal, a second signal, and the carrier frequency into an SSB signal; and
an arm, coupled to both ends at which the first and second Mach-Zender interferometers, for splitting the carrier frequency and outputting a split portion to the first and second Mach-Zender interferometers.

2. The SSB modulator module of claim 1, wherein the arm comprises a y-branch waveguide.

3. The SSB modulator module of claim 2, further comprising a variable optical attenuator disposed at one end of the arm.

4. The SSB modulator module of claim 1, wherein the arm crosses between the first and second Mach-Zender interferometers and couples both ends at which the first and second Mach-Zender interferometers are connected.

5. The SSB modulator module of claim 4, further comprising a variable optical attenuator located on the arm.

6. A single side band (SSB) modulator device comprising:
a light source for generating a carrier frequency;
a hybrid coupler for generating first and second signals having a 90° phase difference; and
an SSB modulator module comprising first and second Mach-Zender interferometers for generating an SSB signal obtained by modulating the carrier frequency and first and second signals, and an arm for splitting the carrier frequency and outputting a split portion to the first and second Mach-Zender interferometers.

7. The SSB modulator device of claim 6, wherein the arm comprises a y-branch waveguide.

8. The SSB modulator device of claim 6, further comprising a variable optical attenuator located on the arm.
